(19) United States
(12) Patent Application Publication
(10) Pub. No.: US 2014/0040013 A1
(43) Pub. Date: Feb. 6, 2014

(54) System and Method for Tracking Influence of Online Advertisement on In-Store Purchases

(71) Applicants: Albert ZHAI, San Francisco, CA (US); Ruxi ZHANG, Richmond, CA (US); Kerem TOMAK, San Francisco, CA (US)

(72) Inventors: Albert ZHAI, San Francisco, CA (US); Ruxi ZHANG, Richmond, CA (US); Kerem TOMAK, San Francisco, CA (US)

(73) Assignee: MACY'S DEPARTMENT STORE, INC., San Francisco, CA (US)

(21) Appl. No.: 13/563,332

(22) Filed: Jul. 31, 2012

(51) Int. Cl. G06Q 30/02

(52) U.S. Cl. 705/14.45

(57) ABSTRACT

A method including the steps of generating, using one or more processors, a first statistical model fitted to first data related to in-store purchases resulting from economic browses made by known visitors to an online website, generating, using one or more processors, a bias correction to the first statistical model based on comparison between observed behavior of all unknown visitors to the online website and observed behavior of all known visitors to the online website, applying, using one or more processors, the generated bias correction to the first statistical model so as to obtain a second statistical model fitted to second data related to in-store purchases resulting from economic browses made by unknown visitors to the online website, and calculating, using one or more processors, a total monetary amount resulting from the in-store purchases made by the known and unknown visitors based on the first and second data.

### FIELD OF THE INVENTION

The present disclosure generally relates to systems and method for determining the effectiveness of online advertisements, particularly in regards to how an online advertisement effects in-store sales.

### SUMMARY OF THE INVENTION

A method according to an exemplary embodiment of the present invention comprises the steps of: generating, using one or more processors, a first statistical model fitted to first data related to in-store purchases resulting from economic browses made by known visitors to an online website; generating, using one or more processors, a bias correction to the first statistical model based on comparison between observed behavior of all unknown visitors to the online website and observed behavior of all known visitors to the online website; applying, using one or more processors, the generated bias correction to the first statistical model so as to obtain a second statistical model fitted to second data related to in-store purchases resulting from economic browses made by unknown visitors to the online website; and calculating, using one or more processors, a total monetary amount resulting from the in-store purchases made by the known and unknown visitors based on the first and second data.

In an exemplary embodiment, the method further comprises the step of determining whether a visitor to the online website is a known visitor.

In an exemplary embodiment, the step of determining whether the visitor is known comprises the step of comparing online visitor information captured over the Internet to visitor information captured in-store.

In an exemplary embodiment, the online visitor information is captured using a cookie ID.

In an exemplary embodiment, the step of generating the first statistical model comprises the use of a zero-inflated Poisson-lognormal mixed modeling technique.

In an exemplary embodiment, the method further comprises the step of determining whether an in-store purchase was made as a result of an economic browse by determining whether the amount of time between the economic browse and the in-store purchase is not greater than a predetermined amount of time.

In an exemplary embodiment, the predetermined amount of time is seven days.

A system according to an exemplary embodiment of the present invention comprises: at least one processor; at least one processor readable medium operatively connected to the at least one processor, the at least one processor readable medium having processor readable instructions executable by the at least one processor to perform the following method: generating, using one or more processors, a first statistical model fitted to first data related to in-store purchases resulting from economic browses made by known visitors to an online website; generating, using one or more processors, a bias correction to the first statistical model based on comparison between observed behavior of all unknown visitors to the online website and observed behavior of all known visitors to the online website; applying, using one or more processors, the generated bias correction to the first statistical model so as to obtain a second statistical model fitted to second data related to in-store purchases resulting from economic browses made by unknown visitors to the online website; and calculating, using one or more processors, a total monetary amount resulting from the in-store purchases made by the known and unknown visitors based on the first and second data.

These and other features of this invention are described in, or are apparent from, the following detailed description of various exemplary embodiments of this invention.

### BRIEF DESCRIPTION OF THE DRAWINGS

The features and advantages of the present invention will be more fully understood with reference to the following, detailed description of illustrative embodiments of the present invention when taken in conjunction with the accompanying figures, wherein:

FIG. 1 illustrates tracking of visitors to an online website according to an exemplary embodiment of the present invention; and

FIG. 2 is a flowchart illustrating a method for tracking influence of online advertisement on in-store purchases according to an exemplary embodiment of the present invention.

### DETAILED DESCRIPTION OF EMBODIMENTS OF THE PRESENT INVENTION

In presenting an online advertisement, such as advertisements presented within an online web store, it is important to know how the online advertisement effects customer behavior in terms of actual in-store visits and purchases. For example, such correlation information may be used to determine the most effective online marketing tactic, such as, for example, search engine marketing (SEM), search engine optimization (SEO) and e-mail, to name a few, in terms of maximizing the number and monetary amount of in-store customer purchases resulting from the online marketing. In this regard, in order to obtain a complete statistical model, it is important to take into consideration the in-store behavior of both known and unknown online site visitors. Although the unknown visitors may not be as loyal as known customers, the unknown visitors may still make in-store purchases which should be taken into account in determining the effectiveness of an online advertisement. However, the behavior of unknown visitors, such as visitors whose cookie ID cannot be attributed to any known visitor identification information, cannot be tracked. Accordingly, various exemplary embodiments of the present invention are directed to a system and method for modeling the in-store purchases made by both known and unknown visitors to an associated online advertisement based on comparisons between observed behaviors of all known and all unknown visitors to the advertisement.

The various exemplary embodiments of the present invention described herein may be implemented using one or more computer systems including one or more memory devices, one or more processors, and one or more computer readable media including computer-readable code containing instructions for the one or more processors to perform processing steps. The one or more computers may form part of a network, such as a local area network or a wide area network, such as, for example, the Internet. In exemplary embodiments, the one or more computers may include specialized hardware components and/or standard hardware components.

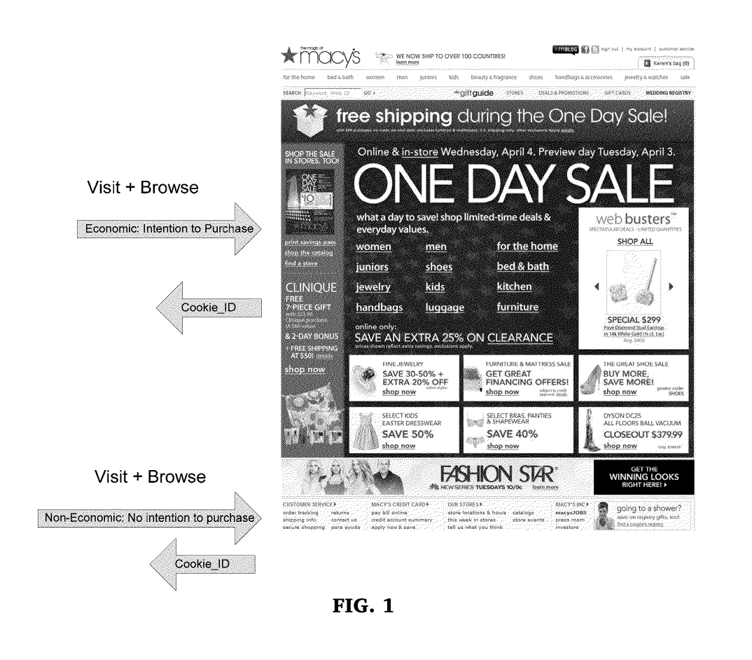

As shown in FIG. 1, according to an exemplary embodiment, the behavior of visitors to an online advertisement may be tracked using cookie IDs. Of particular interest is whether a site visitor has made an economic browse versus a non-economic browse. An economic browse may be, for example, “clicking” or otherwise selecting a link on the site that relates to offered products or services or a link that relates to a discount or coupon. In contrast, a non-economic browse may be one that reflects an interest in a portion of the site that does not relate to offered products or services. For example, a non-economic browse may occur when a visitor reviews company information or initiates contact with customer service through the site.

According to an exemplary embodiment, among the type of data being tracked is whether an economic browse is followed by an in-store purchase within a specified period of time after the browse. An assumption can be made that in-store purchases completed soon after a browse resulted from or were at least somewhat influenced by the browse itself. Thus, the monitored period of time after the browse may be relatively short, such as, for example, on the order of a few days (e.g., 7 days after the browse). It should be appreciated that for the purposes of the present invention any suitable monitored time period after the browse may be used.

According to an exemplary embodiment, a tracked item of information is whether the post-browse, in-store visit results in a purchase within the same family of business (FOB) browsed by the visitor. For example, if an economic browse is performed on the “Beauty” FOB, it is determined whether the in-store purchase following the browse also took place in the “Beauty” FOB. This information provides statistical data regarding the direct correlation between an economic browse within an FOB and a resulting in-store purchase within the FOB.

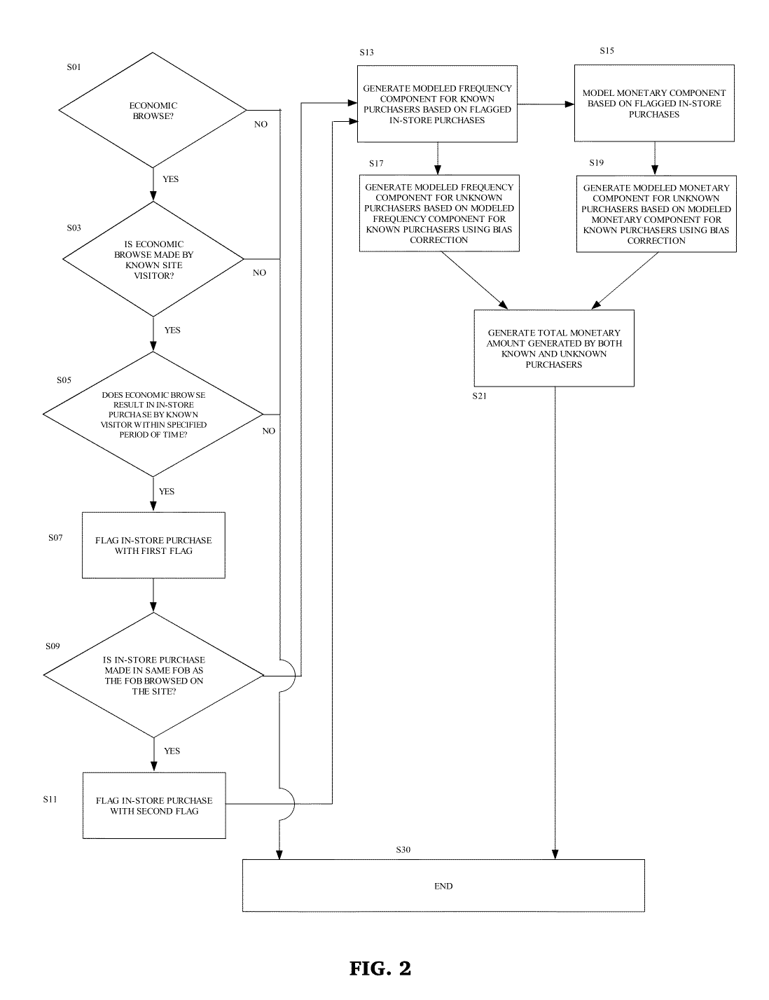

FIG. 2 is a flow chart illustrating a method for tracking influence of online advertisement on in-store purchases according to an exemplary embodiment of the present invention. In step 01 of the method, it is determined whether a particular browse made by a visitor to a site is an economic browse. If the browse is not an economic browse, the process proceeds to steps S30, where the process ends. Otherwise, the flow proceeds to step S03, where it is determined whether the economic browse was performed by a known visitor. In an exemplary embodiment, this determination may be made using cookie IDs. In particular, step S03 may involve determining whether a site visitor's cookie ID matches with a known e-mail address, in which case the visitor may be considered “known”. For example, the visitor's e-mail address may have been opted-in, shared through online credit or debit card use, or some other e-mail capturing method. In contrast, “unknown” site visitors are those that have a cookie ID that for some reason can not be matched to an e-mail address. This may result from, for example, no previous purchases on the site by the visitor, non-sharing of e-mail address, deletion of old cookies, or use of a different browser/computer.

In step S05, a determination is made regarding whether the economic browse results in an in-store purchase by the known site visitor within a specified period of time after the site visit. In this step, the e-mail address of the known site visitor is compared against e-mail addresses captured in-store and corresponding to in-store visitors who have made an in-store purchase after the browse by the site visitor. Any determined matches will indicate that the online visitor has made a subsequent in-store purchase. Any purchases that do not occur within the specified period of time after the online economic browse (e.g., within 7 days after the browse) may be ignored. In order to connect online browsing and store purchases, customer store purchase information (e.g., proprietary card, credit card, debit card, etc.) and customer personal information (e.g., name, address, phone numbers, etc.) may be used to match the customer's online profiles/accounts. Various methods may be used to identify a cookie with a corresponding online profile/account, such as, for example, through a customer's log-in at the site.

In step S07, any in-store purchases made by a previous online visitor within the specified period of time after the online visit may be flagged with a first flag.

In step S09, a determination is made regarding whether the in-store purchase tracked in step SO5 was made in the same FOB as that in which the economic browse was made. If so, the process flows to step S11, where the in-store purchase is flagged with a second flag.

The type of data captured at this point in the process flow may be illustrated as shown in the below Table 1. Table 1 shows, for example, that 5 people have made 13 purchases over a one month period within the “Beauty” FOB, where each purchase was made within 7 days from an economic browse within the “Beauty” FOB portion of the site, and 12 people have made 13 purchases over a one month period within the “Center Core” FOB, where each purchase was made within 7 days from an economic browse within the “Center Core” FOB. Although Table 1 shows data collected for two FOBs, it should be appreciated that such data may be collected for each FOB of the retailer

TABLE 1

Num of MCOM Browsers

| Num of Store Trans Days | BEAUTY | CENTER_CORE |
|---|---|---|
| 0 | 4,062,187 | 3,812,454 |
| 1 | 268,708 | 432,185 |
| 2 | 32,789 | 90,593 |
| 3 | 6,332 | 24,472 |
| 4 | 1,768 | 7,813 |
| 5 | 669 | 2,999 |
| 6 | 269 | 1,250 |
| 7 | 124 | 609 |
| 8 | 75 | 278 |
| 9 | 31 | 136 |
| 10 | 24 | 89 |
| 11 | 12 | 58 |
| 12 | 5 | 33 |
| 13 | 5 | 12 |

A statistical model may be fit to the data shown in Table 1 so that the model captures the following two behaviors: 1) visits to the site followed by an in-store purchase within 7 days (or within some other specified period of time); and 2) store visits which resulted in an in-store purchase within the same FOB visited on the site. In an exemplary embodiment, the model may be generated using, for example, a zero-inflated Poisson-lognormal mixed modeling technique. Other models may be used, such as, for example, a Poisson model or negative binomial models. The result of the fit generates parameters which reflect the site visitor's behavior in terms of frequency of in-store purchases as correlated to online economic browsing. The generated parameters may be, for example, a mean and standard deviation, or any other parameter types that determine the fit of the model.

In step S13, a modeled frequency component may be generated for known visitors using the modeling discussed above. In this regard, the in-store purchases flagged only once reflect visits to the site followed by an in-store purchase within 7 days (or within some other specified period of time), and the in-store purchases flagged twice reflect store visits which resulted in an in-store purchase within the same FOB visited on the site. As previously discussed, a statistical model may be generated that fits the flagged data using, for example, a zero-inflated Poisson-lognormal mixed modeling technique.

In step S15, a modeled monetary component may be generated for known visitors by using tracked data such as, for example, the amount of each in-store purchase made within 7 days (or within some other time period) after an online visit. The monetary component may be modeled using, for example, a robust regression-based model.

In step S17, a modeled frequency component for unknown visitors may be generated by bias correcting the modeled frequency component for the known visitors. Since the in-store behavior of unknown visitors to the site can not be tracked, this bias correction may be based on observed comparison between online behavior of all unknown visitors to the site and online behavior of all known visitors to the site (in this context, “all unknown visitors” should be taken to mean all visitors to the site whose cookie ID cannot be correlated with a user ID, e-mail, etc. and “all known visitors” should be taken to mean all visitors to the site whose cookie ID can be correlated to a user ID, e-mail, etc.). Such comparison at the online level can be extrapolated to reflect in-store behavior. For example, according to an exemplary embodiment of the invention, relative ratios of known vs. unknown customer behavior at the “add-to-cart” level may be observed. The term “add-to-cart” refers to a part of the funnel of activities performed by customers during the shopping process at an ecommerce site in which one or more products are added to a shopping cart/bag, which can be used for final check-out. The “add to cart” behavior may serve as a proxy measurement for purchase propensity. Such relative ratios may be, for example, percentage of unknown customers who do not add anything to the online cart versus percentage of known customers who do not add anything to the online cart, the mean frequency at which unknown customers add an item to the online cart versus the mean frequency at which known customers add an item to the online cart, and the standard deviation of the mean frequency for the unknown customers versus the standard deviation of the mean frequency for the known customers. Based on the observed difference of online purchase behavior between all unknown visitors and known visitors, a model is applied to the modeled frequency component of the known visitors so as to obtain parameters of a corresponding frequency component of the unknown visitors. For example, the method of moments or the generalized method of moments may be applied to the modeled frequency component of the known visitors to obtain parameters of the corresponding modeled frequency component of the unknown visitors.

After the optimal parameters for the unknown customer purchase frequency model are determined, the total number of unknown in-store customers must be determined to establish the distribution of purchase frequencies for unknown customers. In an exemplary embodiment, the total number of unknown online visitors may be calculated by multiplying the total number of unknown cookies (i.e., the cookies that are not correlated to some customer ID, e-mail, etc.) by a discount factor which relates visiting cookies to online visitors. . This discount factor may be determined based on the observed discount factor of known visitors. This observed discount factor may take into account the fact that one visitor may have multiple cookies. For example, if there are 100 cookies and 80 online visitors, the observed discount factor would be 20%. If the discount factor for known visitors is X%, the discount factor for unknown visitors is assumed to be higher than X%. The modeling distribution may then be applied to the total unknown online visitors to obtain the complete distribution of purchase frequency for unknown in-store customers.

In step S19, a modeled monetary component for unknown visitors may be generated by bias correcting the modeled monetary component for the known visitors using the same technique described above in relation to step S17. In particular, the ratio of average add-to cart value for unknown customers versus the average add-to-cart value for known customers may be determined so as to establish a connections/equations between unknown and known visitors, and the method of moments or the generalized method of moments may be used to generate a corresponding modeled monetary component of the unknown visitors.

In step S21, a total monetary amount is generated using the data related to both known and unknown purchasers. According to an exemplary embodiment of the invention, this step may be performed by adding the sale contribution from the known customers with the sale contribution from the unknown customers. This summation provides the aggregate online sales that were influenced by both known and unknown visitors to the online site.

Now that embodiments of the present invention have been shown and described in detail, various modifications and improvements thereon will become readily apparent to those skilled in the art. Accordingly, the spirit and scope of the present invention is to be construed broadly not limited by the foregoing specification.

What is claimed is:

1. A method comprising the steps of:
generating, using one or more processors, a first statistical model fitted to first data related to in-store purchases resulting from economic browses made by known visitors to an online website;
generating, using one or more processors, a bias correction to the first statistical model based on comparison between observed behavior of all unknown visitors to the online website and observed behavior of all known visitors to the online website;
applying, using one or more processors, the generated bias correction to the first statistical model so as to obtain a second statistical model fitted to second data related to in-store purchases resulting from economic browses made by unknown visitors to the online website; and
calculating, using one or more processors, a total monetary amount resulting from the in-store purchases made by the known and unknown visitors based on the first and second data.

2. The method of claim 1, further comprising the step of determining whether a visitor to the online website is a known visitor.

3. The method of claim 2, wherein the step of determining whether the visitor is known comprises the step of comparing online visitor information captured over the Internet to visitor information captured in-store.

4. The method of claim 3, wherein the online visitor information is captured using a cookie ID.

5. The method of claim 1, wherein the step of generating the first statistical model comprises the use of a zero-inflated Poisson-lognormal mixed modeling technique.

6. The method of claim 1, further comprising the step of determining whether an in-store purchase was made as a result of an economic browse by determining whether the amount of time between the economic browse and the in-store purchase is not greater than a predetermined amount of time.

7. The method of claim 6, wherein the predetermined amount of time is seven days.

8. A system comprising:
at least one processor;
at least one processor readable medium operatively connected to the at least one processor, the at least one processor readable medium having processor readable instructions executable by the at least one processor to perform the following method:
generating, using one or more processors, a first statistical model fitted to first data related to in-store purchases resulting from economic browses made by known visitors to an online website;
generating, using one or more processors, a bias correction to the first statistical model based on comparison between observed behavior of all unknown visitors to the online website and observed behavior of all known visitors to the online website;
applying, using one or more processors, the generated bias correction to the first statistical model so as to obtain a second statistical model fitted to second data related to in-store purchases resulting from economic browses made by unknown visitors to the online website; and
calculating, using one or more processors, a total monetary amount resulting from the in-store purchases made by the known and unknown visitors based on the first and second data.

9. The system of claim 8, further comprising the step of determining whether a visitor to the online website is a known visitor.

10. The system of claim 9, wherein the step of determining whether the visitor is known comprises the step of comparing online visitor information captured over the Internet to visitor information captured in-store.

11. The system of claim 10, wherein the online visitor information is captured using a cookie ID.

12. The system of claim 8, wherein the step of generating the first statistical model comprises the use of a zero-inflated Poisson-lognormal mixed modeling technique.

13. The system of claim 8, further comprising the step of determining whether an in-store purchase was made as a result of an economic browse by determining whether the amount of time between the economic browse and the in-store purchase is not greater than a predetermined amount of time.

14. The system of claim 13, wherein the predetermined amount of time is seven days.
